(19) United States
(12) Patent Application Publication
(10) Pub. No.: US 2011/0145220 A1
(43) Pub. Date: Jun. 16, 2011

(54) SYSTEM AND METHOD FOR EXECUTING A QUERY

(76) Inventors: Ramakumar Kosuru, Austin, TX (US); Robert M. Wehrmeister, Austin, TX (US)

(21) Appl. No.: 12/635,272

(22) Filed: Dec. 10, 2009

(51) Int. Cl. G06F 17/30

(52) U.S. Cl. 707/718; 707/E17.136; 707/E17.017

(57) ABSTRACT

There is provided a computer-implemented method of executing a query. An exemplary method comprises optimizing the query. The query may specify multiple operations on corresponding multiple column sets of a table in a database. The exemplary method further comprises partitioning data of the table based on the operations within a single pass of the table. Additionally, the exemplary method comprises performing the operations on the partitioned data in parallel.

### BACKGROUND

In parallel processing, many computational steps (operations) may be performed simultaneously, as opposed to serial processing, in which operations may be performed sequentially. Serial processing is relatively straightforward, and may be accomplished without a great deal of technological sophistication.

Parallel processing, on the other hand, may achieve improved processing and input/output speeds (in comparison to serial processing) by exploiting resources, such as multiple microprocessors and disks. In parallel processing, data and resources may be coordinated in parallel operation to effectively exploit the resources of a parallel processing system.

Traditional database management systems (DBMSs), such as centralized and client-server database systems, typically employ serial processing. As such, traditional DBMSs may not be sophisticated enough to take advantage of the efficiencies of parallel processing.

A parallel DBMS, on the other hand, may be a performance-oriented system that attempts to achieve efficiencies over traditional DBMSs through parallel processing. Efficiencies may be achieved in activities such as loading data, building indexes of database tables, and evaluating and executing database queries. While the data in the databases of a parallel DBMS may be stored in a distributed fashion, the distribution is typically configured to achieve performance efficiencies.

### BRIEF DESCRIPTION OF THE DRAWINGS

Certain exemplary embodiments are described in the following detailed description and in reference to the drawings, in which:

FIG. 1A is a block diagram of a system adapted to execute a query according to an exemplary embodiment of the present invention;

FIG. 1B is a block diagram of a parallel database management system adapted to execute a query according to an exemplary embodiment of the present invention;

FIG. 2 is a block diagram representing a logical view of an operator according to an exemplary embodiment of the present invention;

FIG. 3A is a block diagram representing a logical view of the hybrid exchange operator for SQL STATEMENT 1 according to an exemplary embodiment of the present invention;

FIG. 3B is a block diagram representing a logical view of the hybrid exchange operator for SQL STATEMENT 2 according to an exemplary embodiment of the present invention;

FIG. 3C is a block diagram representing an extended logical view of a query plan 134 according to an exemplary embodiment of the present invention;

FIG. 3D is a block diagram representing a query plan for SQL STATEMENT 2 according to an exemplary embodiment of the present invention;

FIG. 4 is a process flow diagram of a computer-implemented method for executing a query according to an exemplary embodiment of the present invention; and

FIG. 5 is a block diagram showing a tangible, machine-readable medium that stores code adapted to execute a query according to an exemplary embodiment of the present invention.

### DETAILED DESCRIPTION

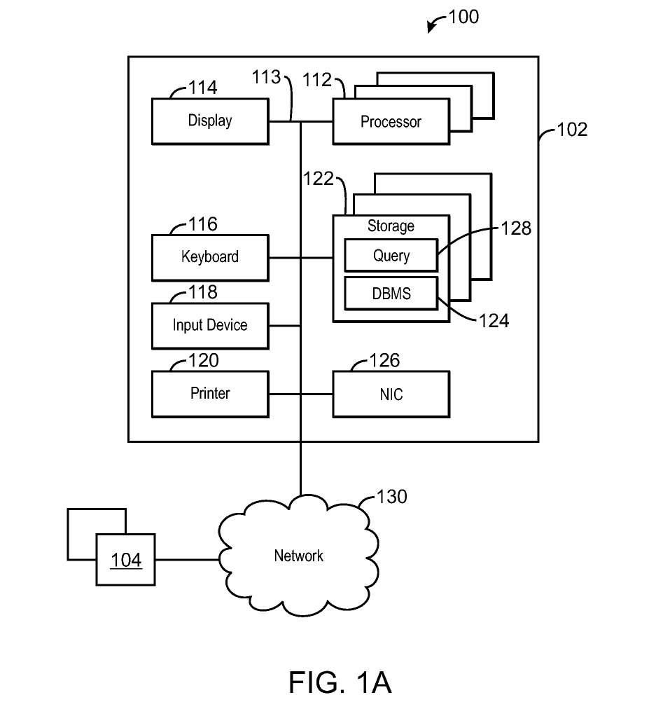

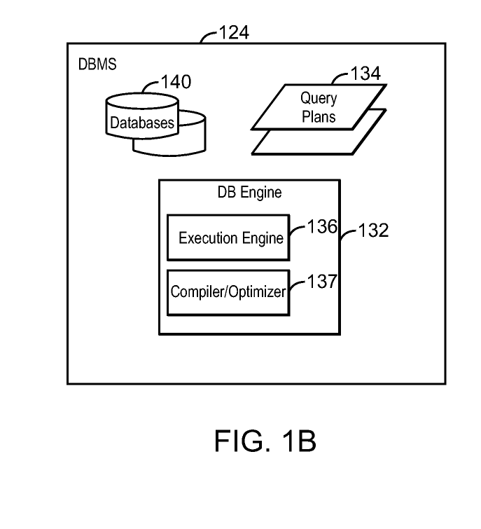

FIG. 1A is a block diagram of a system adapted to execute a query according to an exemplary embodiment of the present invention. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium or a combination of both hardware and software elements.

Additionally, the functional blocks and devices of the system 100 are but one example of functional blocks and devices that may be implemented in an exemplary embodiment of the present invention. Those of ordinary skill in the art would readily be able to define specific functional blocks based on design considerations for a particular electronic device.

The system 100 may include a database server 102, and one or more client computers 104, in communication over a network 130. As illustrated in FIG. 1A, the database server 102 may include multiple processors 112 acting in parallel. The processors 112 may be connected through a bus 113 to a display 114, a keyboard 116, one or more input devices 118, and an output device, such as a printer 120. The input devices 118 may include devices such as a mouse or touch screen.

In an exemplary embodiment of the invention, the system 100 may include multiple database servers 102. In such an exemplary embodiment, the system 100 may include a shared nothing architecture.

A shared nothing architecture may comprise a distributed computing architecture in which each node is independent and self-sufficient. In a shared nothing architecture, there is no single point of contention across the system. Shared nothing may be contrasted with systems that keep a large amount of centrally-stored state information, whether in a database, an application server, or any other similar single point of contention. In such systems, resources, such as memory, may be shared. As a result, some processes may be slowed, or even stopped, while waiting for a separate process to release the shared resource.

The database server 102 may also be connected through the bus 113 to a network interface card (NIC) 126. The NIC 126 may connect the database server 102 to the network 130. The network 130 may be a local area network (LAN), a wide area network (WAN), or another network configuration, such as the Internet. The network 130 may include routers, switches, modems, or any other kind of interface device used for interconnection.

Through the network 130, several client computers 104 may connect to the database server 102. The client computers 104 may be similarly structured as the database server 102, with exception to the storage of a database management system (DBMS) 124. In an exemplary embodiment, the client computers 104 may be used to submit queries to the database server 102 for execution by the DBMS 124.

The database server 102 may have other units operatively coupled to the processor 112 through the bus 113. These units may include tangible, machine-readable storage media, such as storage devices 122.

The storage devices 122 may include media for the long-term storage of operating software and data, such as hard drives. The storage devices 122 may also include other types of tangible, machine-readable media, such as read-only memory (ROM), random access memory (RAM), and cache memory. The storage devices 122 may include the software used in exemplary embodiments of the present techniques.

The storage devices 122 may include the DBMS 124, a defaults table 129, and a query 128. The DBMS 124 may be a set of computer programs that controls the creation, maintenance, and use of databases by an organization and its end users. In an exemplary embodiment of the invention, the DBMS 124 may be a parallel DBMS. The DBMS 124 is described in greater detail with reference to FIG. 1B.

The query 128 may be any of a certain class of common database queries. For example, the query 128 may specify that multiple operations are performed on multiple columns of a database table, view, or join. The operations may include multiple grouping operations with aggregation functions, such as maximum, minimum, average, count, sum and the like. In an exemplary embodiment of the invention, the query 128 may specify that each operation is performed on a different column, or set of columns, with each operating on a different grouping of data. For example, the query 128 may include the following structured query language (SQL) statement:

SELECT COUNT (DISTINCT A),

COUNT (DISTINCT B),
AVG(DISTINCT C) FROM TABLE;

SQL STATEMENT 1

As shown, the SQL STATEMENT 1 specifies multiple aggregate functions COUNT DISTINCT, COUNT DISTINCT, and AVG DISTINCT. The COUNT function may return the number of rows in TABLE with non-NULL values in column A, with the data to be grouped on column A. As shown, each distinct aggregate function operates on a different grouping of the data.

The second COUNT DISTINCT function may return the number of rows in TABLE with distinct non-NULL values in column B, with the data to be grouped on column B. The AVG DISTINCT function may return the average of the distinct non-Null values for column C, with the data to be grouped on column C.

In an exemplary embodiment of the invention, any particular aggregate function may be performed on different data groupings. SQL STATEMENT 2 below illustrates one such example:

SELECT A, B, MIN(C ) FROM TABLE

GROUP BY GROUPING SETS (A,B);

SQL STATEMENT 2

As shown, the SQL STATEMENT 2 includes a MIN function on column C, a grouping on columns A and B independently, and then combining the two group-by output streams through a UNION ALL operation. The same aggregation function MIN(C) may be used in both groupings.

FIG. 1B is a block diagram of a parallel database management system adapted to execute a query according to an exemplary embodiment of the present invention. As illustrated, the DBMS 124 may include query plans 134, an execution engine 136, an optimizer 137, and several databases 140.

The query plans 134 may each specify alternate ways to perform the query 128. The execution engine 136 may execute one of the query plans 134 against the databases 140 to produce a query result.

The optimizer 137 may generate the query plans 134 from the query 128 itself. The optimizer 137 may also select an optimal query plan 134 for the execution engine 136 to execute. The selection may be based on estimated processing costs of the generated query plans 134.

The query plan 134 may include one or more operators. The operators of the query plan 134 may have predefined behaviors that accomplish the work of the query. In particular, operators may act on inputs, referred to as input streams, and produce outputs, referred to as output streams.

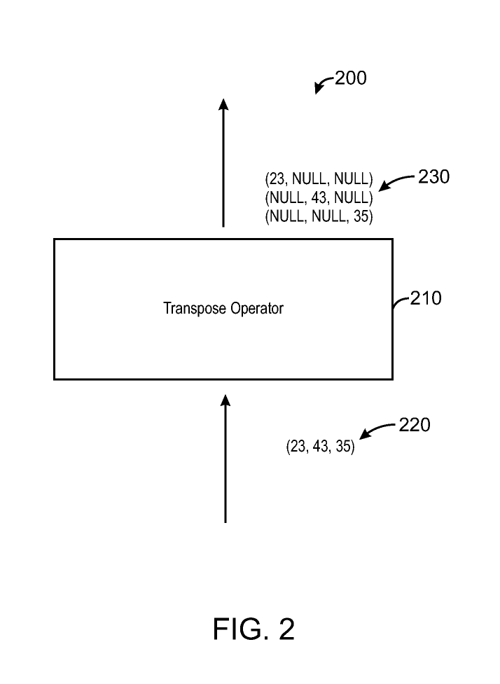

FIG. 2 is a block diagram representing a logical view 200 of an operator according to an exemplary embodiment of the present invention. In this example, the operator illustrated is a transpose operator 210. The transpose operator 210 along with a group-by operator is one possible implementation for performing multiple groupings for multiple aggregates in the query plans 134.

Put simply, the transpose operator may expand a single input row into multiple rows such that each column value in the input row is used to create a new row. In this example, the input stream 220 includes a single row of data with column values, “(23, 43, 35).” The transpose operator 210 may convert the single row of 3 columns to 3 rows, one for each column value of the input stream 220. As shown, the output stream 230 contains 3 rows, one for each column value of the input stream 220, “23,” “43,” and “35.”

Within the query plan 134, the output stream for one operator may become the input stream for a subsequent operator. For example, to implement multiple groupings, the output stream 230 may be used as an input stream to a group-by operator. The group-by operator may perform the work of the grouping and aggregation function, taking advantage of the new format of the transposed data in the output stream 230.

However, as shown, the size of the output stream 230 may be significantly greater than the size of the input stream 220. As such, subsequent operations may become unwieldy in the face of large input streams with large numbers of groupings. However, parallel processing may be used for significantly large data streams.

In a parallel DBMS, the query plans 134 may also include an exchange operator. The exchange operator may partition an input stream of data into multiple streams. As such, subsequent operations may be performed, each on one portion of the partitioned data.

For example, the exchange operator may be used in a query plan 134 for the following SQL:

SELECT COUNT(DISTINCT A), SUM(DISTINCT B) FROM
TABLE;

SQL STATEMENT 3

If TABLE includes 2 million rows, the exchange operation may distribute the 2 million rows among multiple streams to subsequent operations. The transpose and group-by operations may then be performed in parallel, computing the sums for each partition of rows. The disparate output streams of the parallel operations may then be input to another operator that computes the sum of each of the sums computed in parallel, providing a SUM result for SQL STATEMENT 3.

While the exchange operator may be efficient, executing the query plan 134 may become unwieldy when there are a large number of rows in the input and the query plan 134 specifies many groupings. For each grouping, the transpose operator may produce an additional row of the input. Additionally, each row produced may contain a column for each grouping. In other words, the size of the data may be increased by a factor of the number of groupings. As a result, very large data sets with multiple groupings may overwhelm the group-by operator, even with the use of the exchange operator. This may incur a significant cost in I-O, particularly for large tables.

In an exemplary embodiment of the invention, the query plans 134 may include a new hybrid exchange operator as part of the implementations of multiple groupings. The hybrid exchange operator may partition the data in a single pass. Additionally, the hybrid exchange operator may be used in place of a transpose operator for multiple groupings, or in place of the exchange and transpose operators in the case of a parallel evaluation of multiple groupings. This may help avoid the expansion in size between the input stream and output stream.

Inclusion of the hybrid exchange operator in the query plan 134 may also be supplemented with a new combine operator that combines outputs of the parallel operations. As such, the combine operator may represent the functionality of a JOIN, UNION, or similar SQL clause.

For example, instead of a partitioning function that partitions data by rows for each aggregate function, the hybrid exchange operator may partition the data according to the groupings (for example the columns specified in each distinct aggregate function or the columns specified in the grouping sets). As such, if each input row includes n columns, C₁, C₂, . . . , Cₙ, the hybrid exchange may produce n partitions each containing one column.

In an exemplary embodiment of the invention, a number of partitioning functions may be applied to each row of a table. Each partitioning function may be applied to the same input row, but may extract a distinct column, or combination of columns. In this manner, the operators for each grouping may receive a part of each row. The parts may not be disjoint, depending on the semantics of the query 128.

It should be noted that splitting the input streams by columns may result in functional parallelism, as each output stream of the hybrid exchange operator may be input to different operators, each of which may perform different groupings and different aggregate functions. In an exemplary embodiment of the invention, the different operators may perform the same aggregate functions, but on different columns.

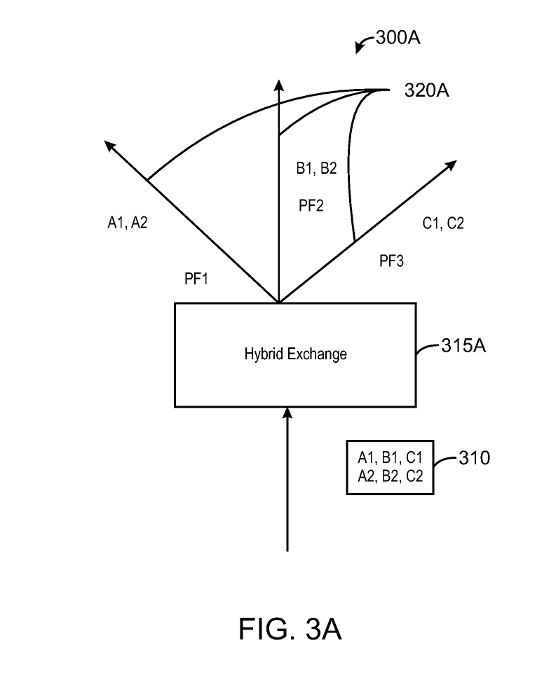

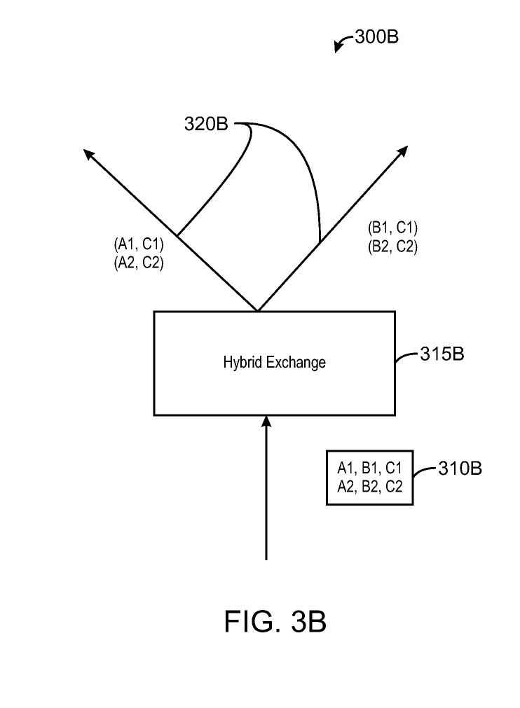

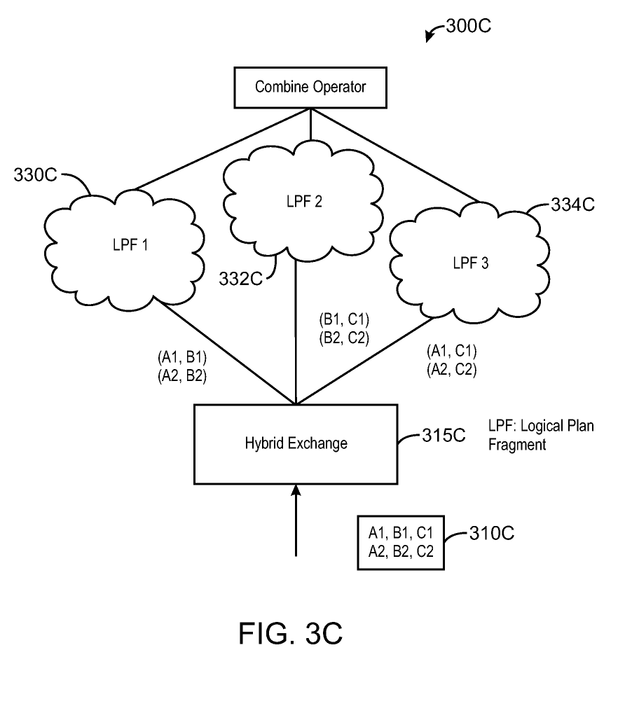

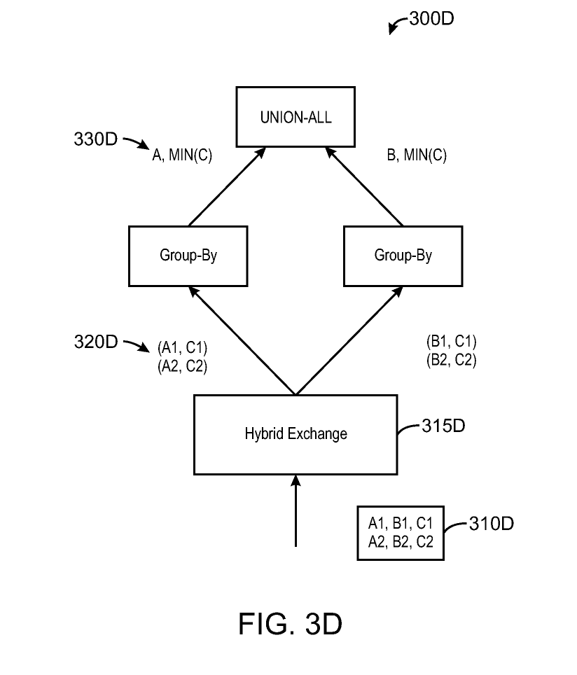

FIG. 3A is a block diagram representing a logical view 300A of the hybrid exchange operator for SQL STATEMENT 1 according to an exemplary embodiment of the present invention. The logical view 300A includes an input stream 310, the hybrid exchange operator 315A, and 3 output streams 320A. As shown, the input stream 310 includes 2 rows of a table, which may be represented as follows:

TABLE 1

| COLUMN A | COLUMN B | COLUMN C |
|---|---|---|
| A1 | B1 | C1 |
| A2 | B2 | C2 |

SQL STATEMENT 1 includes 3 distinct aggregate functions, one for each of columns A, B, and C. As such, the hybrid exchange operator 315A may apply a partitioning function (PF) for each of the aggregate functions. PF1 may partition the values for column A from each row of TABLE 1. Similarly, PF2 and PF3 may partition the values for columns B and C, respectively from each row of TABLE 1.

As shown, each output stream 320A may contain the values of only one column. Each output stream 320A may then be input to operators for performing the grouping and aggregate functions.

FIG. 3B illustrates a block diagram representing a logical view 300B of the hybrid exchange operator for SQL STATEMENT 2 according to an exemplary embodiment of the present invention. The logical view 300B includes the input stream 310B, the hybrid exchange operator 315B, and 2 output streams 320B.

SQL STATEMENT 2 includes aggregate function, MIN (C). As such, PF4 may partition the values for both columns A and C. However, PF5 may partition the values for both columns B and C. In an exemplary embodiment of the invention, the partitioning functions for a particular hybrid exchange operator may produce output streams that overlap. As such, the values for column C may be included in both output streams of the hybrid exchange operator 315B.

FIG. 3C is a block diagram representing an extended logical view of a query plan 134 according to an exemplary embodiment of the present invention. It should be noted that the new hybrid exchange and combine operators may represent extensions upon existing operators for optimization and execution. As shown the output streams of the hybrid exchange operator 315C are input to logical plan fragments (LPFs) 330C, 332C, and 334C. The LPFs 330C, 332C, and 334C may represent any legal operations specified by the optimizer 137. For example, the output streams may be further load balanced by using a traditional exchange operator within one of the LPFs 330C, 332C, and 334C.

FIG. 3D is a block diagram representing a query plan 134 for SQL STATEMENT 2 according to an exemplary embodiment of the present invention. The combine operator is a UNION ALL operation in this embodiment. The combine operator may be different based on semantics of a SQL query.

FIG. 3D contains two group-by operators that take input from the hybrid exchange operator and then perform two different group-by operations. The outputs of the group-by operations is input to the UNION-ALL operation in this embodiment.

It should be noted that the hybrid exchange operator may provide an improvement in efficiencies for calculating statistics, such as those include in histograms. In an exemplary embodiment of the invention, histograms could be generated by queries 128 that specify aggregation functions for multiple columns with multiple groupings within a single query 128. By optimizing such queries 128 using the hybrid exchange operator, statistics that would normally be computed with several passes over data may be accomplished with a single pass.

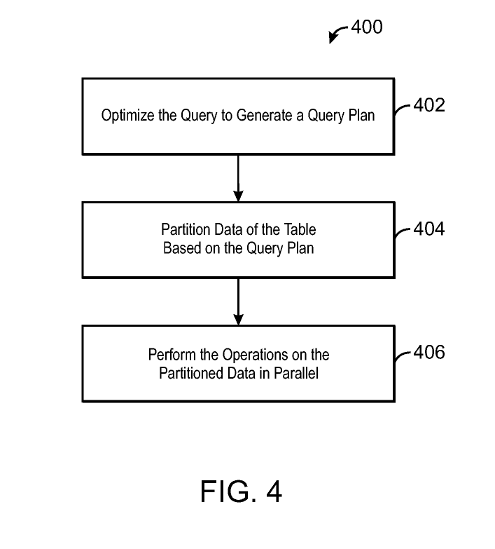

FIG. 4 is a process flow diagram of a computer-implemented method for executing a query according to an exemplary embodiment of the present invention. The method is generally referred to by the reference number 400, and may be performed by the DBMS 124. It should be understood that the process flow diagram for method 400 is not intended to indicate a particular order of execution.

The method begins at block 402. At block 402, the DBMS 124 optimizes the query 128, thereby generating a query plan 134 for execution by the execution engine 136. The optimizer 137 may include any legal operations, including the new hybrid exchange and combine operators.

At block 404, the DBMS 124 partitions data of the table based on the operations. As stated previously, the operations may include aggregation functions, such as MIN, MAX, COUNT, SUM, AVG and the like. At block 406, the DBMS 124 performs the operations on the partitioned data in parallel.

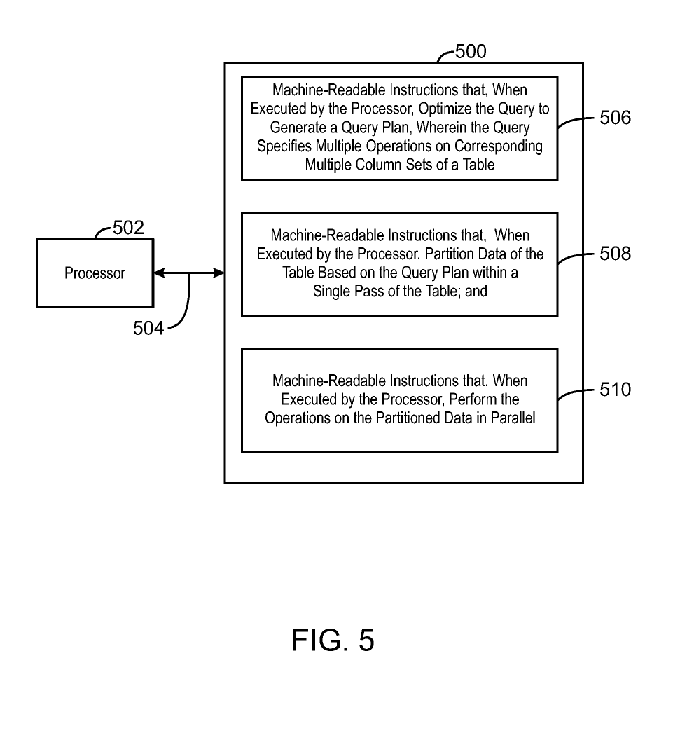

FIG. 5 is a block diagram showing a tangible, machine-readable medium that stores code adapted to execute the query 128 according to an exemplary embodiment of the present invention. The tangible, machine-readable medium is generally referred to by the reference number 500. The tangible, machine-readable medium 500 may correspond to any typical storage device that stores computer-implemented instructions, such as programming code or the like.

Moreover, tangible, machine-readable medium 500 may be included in the storage 122 shown in FIG. 1. When read and executed by a processor 502, the instructions stored on the tangible, machine-readable medium 500 are adapted to cause the processor 502 to execute the query 128.

A region 506 of the tangible, machine-readable medium 500 stores machine-readable instructions that, when executed by the processor 502, receive a query that specifies a plurality of aggregate functions on a corresponding plurality of columns within a database table. A region 508 of the tangible, machine-readable medium 500 stores machine-readable instructions that, when executed by the processor 502, optimize the query. The query may specify multiple operations on corresponding multiple column sets of a table.

A region 510 of the tangible, machine-readable medium 500 stores machine-readable instructions that, when executed by the processor 502, partition data of the table based on the operations. A region 512 of the tangible, machine-readable medium 500 stores machine-readable instructions that, when executed by the processor 502, perform the operations on the partitioned data in parallel, whereby the operations are performed within a single pass of the data.

What is claimed is:

1. A computer-implemented method of executing a query, comprising:
optimizing the query to generate a query plan, wherein the query specifies multiple operations on corresponding multiple column sets of a table in a database;
partitioning data of the table based on the query plan within a single pass of the table; and
performing the operations on the partitioned data in parallel.

2. The computer-implemented method of claim 1, wherein partitioning the data comprises partitioning the data along the column sets.

3. The computer-implemented method of claim 2, wherein partitioning along the column sets comprises applying multiple partitioning functions corresponding to the multiple column sets to each row of the table.

4. The computer-implemented method of claim 1, wherein each of the column sets comprise one or more columns of the table.

5. The computer-implemented method of claim 1, wherein the table comprises one of:
a database table;
a database join;
a database view; and
combinations thereof.

6. The computer-implemented method of claim 1, wherein performing the operations in parallel comprises creating multiple results corresponding to the multiple operations.

7. The computer-implemented method of claim 6, comprising combining the multiple results into a singular result set.

8. The computer-implemented method of claim 1, wherein the operations comprise one or more groupings of the column sets, wherein the groupings comprise one or more aggregation functions.

9. The computer-implemented method of claim 1, wherein the operations comprise distinct aggregate functions.

10. A computer system for executing a query, the computer system comprising:
multiple processors adapted to execute stored instructions; and
a memory device that stores instructions, the memory device comprising:
a parallel database management system (DBMS);
computer-implemented code adapted to optimize the query to produce a query plan, wherein the query specifies multiple operations on corresponding multiple column sets of a table in the parallel DBMS;
computer-implemented code adapted to partition data of the table based on the query plan within a single pass of the table; and
computer-implemented code adapted to perform the operations on the partitioned data in parallel on the multiple processors.

11. The computer system of claim 10, wherein the computer-implemented code adapted to partition data of the table comprises computer-implemented code adapted to partition the data along the column sets.

12. The computer system of claim 11, wherein the computer-implemented code adapted to partition the data along the column sets comprises the computer-implemented code adapted to apply multiple partitioning functions corresponding to the multiple column sets to each row of the table.

13. The computer system of claim 10, wherein the column sets comprise one or more columns of the table.

14. The computer system of claim 10, wherein the computer-implemented code adapted to perform the operations in parallel comprises the computer-implemented code adapted to create multiple results corresponding to the multiple operations.

15. The computer system of claim 14, comprising computer-implemented code adapted to combine the multiple results into a singular result set.

16. A tangible, machine-readable medium that stores machine-readable instructions executable by a processor to execute a query, the tangible, machine-readable medium comprising:
machine-readable instructions that, when executed by the processor, optimize the query to generate a query plan, wherein the query specifies multiple operations on corresponding multiple column sets of a table;
machine-readable instructions that, when executed by the processor, partition data of the table based on the query plan within a single pass of the table; and
machine-readable instructions that, when executed by the processor, perform the operations on the partitioned data in parallel.

17. The tangible, machine-readable medium of claim 16, wherein the machine-readable instructions that, when executed by the processor, partition the data comprise machine-readable instructions that, when executed by the processor, partition the data along the column sets.

18. The tangible, machine-readable medium of claim 17, wherein the machine-readable instructions that, when executed by the processor, partition the data along the column sets comprises machine-readable instructions that, when executed by the processor, apply multiple partitioning functions corresponding to the multiple column sets to each row of the table.

19. The tangible, machine-readable medium of claim 16, wherein the machine-readable instructions that, when executed by the processor, perform the operations in parallel comprise machine-readable instructions that, when executed by the processor, create multiple results corresponding to the multiple operations.

20. The tangible, machine-readable medium of claim 19, comprising machine-readable instructions that, when executed by the processor, combine the multiple results into a singular result set.
